(19) United States
(12) Patent Application Publication
(10) Pub. No.: US 2012/0041583 A1
(43) Pub. Date: Feb. 16, 2012

(54) MEASUREMENT SYSTEM AND METHOD

(76) Inventors: Joshua Conley, Sylvania, OH (US); Stephen Murphy, Perrysburg, OH (US)

(21) Appl. No.: 13/210,784

(22) Filed: Aug. 16, 2011

Related U.S. Application Data
(60) Provisional application No. 61/374,166, filed on Aug. 16, 2010.

(51) Int. Cl. G01N 21/00; G01B 11/14; G06F 17/00; G01B 11/24

(52) U.S. Cl. 700/110; 356/237.1; 356/601; 356/614

(57) ABSTRACT

A method of measuring planar defects in a substrate may include positioning a sensor proximate to an area configured to receive a substrate.

This application claims priority under 35 U.S.C. §119(e) to Provisional Application No. 61/374,166, filed on Aug. 16, 2010, which is hereby incorporated by reference in its entirety.

### FIELD OF THE INVENTION

The present invention relates to photovoltaic modules and methods of production.

### BACKGROUND OF THE INVENTION

Glass plates can be coated with a variety of materials to alter the glass properties, for example, to provide anti-reflective, conductive, light emitting, or photovoltaic surfaces. During or after deposition to create one or more of these surfaces, a defect, or a plurality of defects, may develop on the surface and/or a displacement of a portion of the substrate from its intended position or shape can occur. These defects and/or displacements can distort the performance of the ultimate device incorporating the glass.

### BRIEF DESCRIPTION OF THE DRAWINGS

FIG. 1 is a schematic of a system for measuring defects in a substrate.

FIG. 2 is a schematic of a system for measuring defects in a substrate.

### DETAILED DESCRIPTION OF THE INVENTION

One or more coatings or layers may be created (e.g., formed or deposited) adjacent to a substrate (or superstrate). The substrate may contain any of a variety of materials, including, for example, a glass, or a semiconductor wafer (e.g., silicon). For example, one or more layers may be formed adjacent to a glass plate. Each layer may contain multiple materials or layers, and can cover all or a portion of the glass substrate and/or all or a portion of the layer or substrate underlying the layer. For example, a “layer” can include any amount of any material that contacts all or a portion of a surface. One or more edges of the substrate may be substantially free of coating, either by selectively applying the coating, or by removing (e.g., ablating) one or more portions of the coating away from the substrate. Such substrates may be suitable for a variety of uses, including, for example, use as a photovoltaic module substrate.

During fabrication of an object such as a photovoltaic module, particularly during a high-temperature processing step, one or more defects, deformations, and/or displacements may develop in the structure of the object, causing it to depart from its intended shape or profile. For example, a substantially planar object such as a substrate for use in a photovoltaic module can have an edge that is susceptible to displacement out of plane during or after thermal processing. This displacement can be caused by softening of the substrate material (for example at a temperature above about 600 degrees C.) and subsequent or simultaneous contact by a roller or conveyor, thereby causing the displacement. Another example of the kind of displacement that can occur in a portion of an object is where an object or portion thereof has a curved intended profile and a displacement occurs causing the object or portion thereof to assume a straightened or substantially planar shape or profile, contrary to the intended profile.

In other examples where the object is a substrate having a substantially planar intended shape or profile, the surface of a substrate may be sloped at various parts of the surface of the substrate; the substrate may contain various structural inconsistencies; the overall shape of the substrate may vary substantially from its pre-processing form; or the volume of the substrate may expand or contract at various areas. These defects, deformations, and/or displacements may appear as bends, or kinks in the substrate. These defects can occur on and within any area of the substrate, including, for example, along or substantially close to one or more edges of the substrate, or along any of the coated or non-coated sections of the substrate.

Defects may occur for any of a variety of reasons. Glass (a commonly used substrate material) is an amorphous structure. As such, the coefficient of thermal expansion across and throughout glass substrates may vary substantially, potentially resulting in a non-uniform expansion of the substrate when exposed to a high temperature. This can result in varying thicknesses at certain areas, including, for example, what may appear to be bends or “kinks.” For example, during deposition of the various coating layers, the substrate may be exposed to a substantially high temperature, including, for example, above about 40° C., above about 50° C., above about 60° C., or above about 70° C. For example, one or more active or semiconductor layers (e.g., cadmium sulfide and cadmium telluride, or a layer of cadmium, indium, gallium, and selenium) may be deposited adjacent to the substrate. The semiconductor layers may be formed adjacent to the substrate using any suitable high-temperature technique, including, for example, vapor transport deposition or close space sublimation. These and other similar high temperature processes may cause non-uniform thermal expansion of the glass substrate to occur, resulting in one or more defects which may affect module performance.

Similarly, detectable deformations and/or displacements can occur in any portion or the whole of any object made from a material susceptible to softening during a thermal process, including objects having plastic, polycarbonate, mineral, metal, glass, fiber, or polymer components, or any suitable combinations of any such materials, or any other suitable materials. Detectable deformations can occur during a high-temperature thermal process step and/or steps of a manufacturing process, where the material is subjected to a temperature equal to or greater than the temperature at which the material softens and becomes vulnerable to being deformed and/or a portion displaced. Such high-temperature thermal processes can include annealing, tempering, coating, or any combination of these or any other high-temperature thermal processes.

In the case of a substrate, such as a photovoltaic substrate, defects may also occur due to the disparity in coefficients of thermal expansion for the substrate and the various coating layers deposited thereon. As noted above, various layers may be formed adjacent to the substrate. Each of these layers may have a coefficient of thermal expansion different from that of the substrate. These layers may expand (e.g., deform) in many different ways, including, for example, in such a manner as to cause deformation of the supporting substrate. Thus the form and extent to which the substrate may deform is not entirely predictable. Nor is it wholly dependent upon characteristics of the substrate itself.

By way of non-limiting example, one or more barrier layers may be formed adjacent to (e.g., directly on) the substrate. The barrier layer may include any suitable barrier material, including, for example, silicon nitride, aluminum-doped silicon nitride, silicon oxide, aluminum-doped silicon oxide, boron-doped silicon nitride, phosphorous-doped silicon nitride, silicon oxide-nitride, or tin oxide. A transparent conductive oxide layer may be formed adjacent to the one or more barrier layers. The transparent conductive oxide layer may contain any suitable material, including, for example, a layer of cadmium and tin (e.g., cadmium stannate). A buffer layer may be formed adjacent to the transparent conductive oxide layer. The buffer layer may include any suitable material, including, for example, tin oxide, indium oxide, zinc oxide, zinc tin oxide, and any other suitable combinations of high resistance oxides. The barrier layer, transparent conductive oxide layer, and buffer layer may be part of a transparent conductive oxide stack. The layers within the transparent conductive oxide stack can be formed using any of a variety of deposition techniques, including, for example, low pressure chemical vapor deposition, atmospheric pressure chemical vapor deposition, plasma-enhanced chemical vapor deposition, thermal chemical vapor deposition, DC or AC sputtering, spin-on deposition, or spray-pyrolysis. One or more active or semiconductor layers may be formed adjacent to the transparent conductive oxide stack, including, for example, a cadmium telluride layer formed adjacent to a cadmium sulfide layer. Any of these stack or semiconductor layers may have varying coefficients of thermal expansion from one another, or the glass substrate.

While defects within the module substrate (or any substrate) are somewhat commonplace, there are limits on how much bend or deviation from the preferred plane is acceptable, particularly if the defects will have a substantial impact on the intended use. With photovoltaic module substrates, for example, there is a threshold beyond which the defects may impair proper functioning and performance of the resulting device, for example a deflection of about 1 mm or greater resulting from a substrate becoming deformable by, for example, a conveyor or roller during thermal processing of the substrate. An edge deflection, which can resemble a kink in the substrate, can affect the manufacture of the photovoltaic module, including the lamination process, or the ability of the module to pass subsequent performance testing.

Detecting or measuring defects on a surface or edge of a substrate, before, during, or after fabrication of a photovoltaic module can provide valuable information during device fabrication that can be used to adjust process parameters. This can be achieved by positioning one or more sensors proximate to a zone or area configured to receive the substrate. Sensors can be mounted proximate to the substrate (for example above the substrate) during substrate transport at any suitable position, for example, subsequent to the position of the material coating apparatus. Sensors can be shielded from light to maintain the integrity of measurements taken by the sensors. For example, the sensors can be positioned in a guard or chamber that blocks ambient light from the sensing environment. The sensors may be of any suitable type, including, for example, any suitable optical micrometer or laser displacement sensor. The sensors may be configured to detect or measure any sort of defect in the module substrate, including, for example, planar distortion, and any bends or “kinks” on or within any portion of the substrate, including, for example, on one or more coated or non-coated edges.

The sensors may be placed in an orientation substantially proximate to the substrate to allow detection or measurement of one or more dimensions of the substrate. For example, a first sensor may be placed above or below a first edge of the substrate, and a second sensor may be placed above or below a second edge of the substrate. The first and second sensors may be configured to measure the edge defects on the leading and/or trailing edge of the substrate. The substrate may be positioned on a shuttle, or any other suitable means for transporting the substrate. The substrate may be positioned adjacent to one or more conveyor rollers and transported proximate to the one or more sensors. The substrate may be transported along an axis, along which the one or more sensors may be positioned to measure defects along an edge of the substrate as it passes along the axis. The one or more sensors can be aligned on a common axis perpendicular to the transport axis. The transport axis may be configured to transport multiple substrates in an assembly line. The substrates traversing the transport axis may have one or more coating layers deposited thereon, or they may be substantially or completely coating-free. For example, the transport axis may include a portion of an assembly line, where the substrates have deposited thereon one or more semiconductor layers (e.g., a cadmium telluride layer on a cadmium sulfide layer). In this scenario, the one or more sensors may be configured to detect or measure defects within the substrate post-fabrication. Alternatively, the transport axis may include a portion of an assembly line where substrates pass which have only one or no coatings deposited thereon. In such a scenario, the one or more sensors may be configured to detect or measure defects within the substrate before or during fabrication of the module.

The sensors may be used in conjunction with one or more additional sensors configured to characterize the opto-electronic properties of the module. Any suitable sensors may be used for this task, including, for example, spectral reflection/transmission sensors, haze sensors, sheet resistance sensors, or photo-luminescence sensors. These additional sensors may be placed in any suitable position substantially proximate to the zone through which the module substrates pass, including, for example, substantially close to any other sensor, or above or below the transport axis or module substrate.

All of the aforementioned sensors may be electrically connected to a microprocessor, which may be configured to receive and process the data. The microprocessor may have stored within it a threshold value, representing a maximum defect level for the threshold. This threshold value may correspond to the maximum acceptable deviation from an original substrate profile stored within the microprocessor. The original substrate profile may include information representing the original measurements for volume or area of the substrate before manufacturing. These values may be stored in a memory component which may be in connection with the microprocessor, or a part of the microprocessor itself. This original profile may be obtained prior to manufacturing of the substrate (i.e., deposition of various layers on the surface of the substrate). The original profile may correspond to an actual profile of the substrate being measured or to a theoretical substrate, for which the theoretical measurement values represent a reasonable estimate of what the substrate's area and volume parameters actually are.

The microprocessor may compare the values received from the sensors, which may equate to measurements of area and volume across various areas of the current substrate being measured, with the original profile. Any disparity noted between the original profile and the measured values may be compared to a threshold value. If the disparity between the measured values and the original profile exceeds the threshold value, the microprocessor may output an alert signal. The alert signal may correspond to an actual alert in the form of a sound or light, or it may be a HIGH or LOW voltage signal (i.e., in the form of a −5 V, 0 V, or 5 V output). The alert signal may take a digital or analog form (i.e., from about 0 to about 20 mA). The microprocessor may output the alert signal to a computer, computer network, or any other system. The signal may be output by any suitable means of hardwire or wireless communication. Upon receiving the signal, the computer, computer network, or other system may initiate an automatic response. For example, the manufacturing line or system may be halted so that the module may be removed from the assembly line for inspection. The substrate may also be redirected to another area or zone of manufacturing. This new manufacturing zone may contain means for curing one or more measured defects in the substrate, or it may permit further analysis and inspection of the substrate to determine if the substrate should be scrapped, or if further processing may continue. Data from the sensors may be compiled and manipulated in any suitable manner. For example, the data can be used to refine the manufacturing process and equipment and control thereof in any suitable way.

The substrate may be transported to a designated zone for curing one or more of the defects measured or detected in the substrate. For example, the temperature of the processing environment may be raised or lowered to control the thermal expansion of the substrate. This can be achieved via raising or lowering the temperature of one or more heaters positioned proximate to the substrate. This curing step may be executed during processing of the module. For example, sensors may be positioned proximate to the substrate during deposition of one or more layers. The sensors may indicate to the system that the parameters of the deposition environment are leading to excessive deformation. The system may be configured to adjust the temperature of the environment in response to the detected defects. This rectification step may take place after deposition of one or more coating layers as well.

The methods and systems discussed herein may be used to map the surface profile of the substrate. These measurements may be used as a real-time indicator of temperature, coating, or material characteristics in a tempering, annealing, deposition or other manufacturing or testing process. Thus the characteristics of the substrate may be monitored at all times of the manufacturing process to ensure that the substrate maintains a suitable form to ensure optimum performance of the resulting photovoltaic module.

In one aspect, a method of measuring a displacement in a portion of an object having an intended shape can include detecting a displacement of a portion of an object compared to the intended placement of the portion with one or more sensors positioned along a first axis for transporting the object. The method may include positioning a sensor proximate to a zone configured to receive the object. The zone configured to receive a substrate may be positioned along a first axis for transporting the object.

The one or more sensors may include two sensors aligned along a second axis substantially perpendicular to the first axis. The two sensors may be positioned on opposite sides of the first axis. The detecting may occur as the object traverses the first axis. The method may include aligning two sensors along a second axis, substantially perpendicular to the first axis and intersecting the zone configured to receive the object. The two sensors may be positioned on opposite sides of the zone configured to receive the object. The detecting may include measuring a displacement along an edge of the object. The object may include a planar surface. The object may include a substrate. The object may include a substrate configured for use in a photovoltaic module. The substrate can include glass. The detecting may include measuring displacement along a non-coated region of the substrate. In another aspect, a method of measuring a defect in a portion of an object having an intended profile can include determining an intended object profile. The method may include determining an actual object profile for an object traversing a first axis for transporting the object. The method may include comparing the intended object profile with the actual object profile to determine a defect value. The method may include positioning a sensor proximate to a zone configured to receive a portion of the object. The zone configured to receive a portion of the object may be positioned along the first axis for transporting the object.

The defect value may correspond to one or more defects on a portion of the object. The portion can include an edge portion. The defect value may correspond to one or more defects on a non-coated edge of the object. The object may include a planar substrate. The intended object profile may correspond to a set of measurements for a theoretical object. The method may include comparing the defect value to a threshold value. The method may include halting processing of the substrate if the defect value exceeds the threshold value. The method may include relocating the substrate to an inspection zone if the defect value exceeds the threshold value. The method may include continuing with processing of the substrate if the defect value does not exceed the threshold value. The method may include curing one or more defects in the substrate if the defect value exceeds the threshold value. The curing may include raising or lowering a temperature in an atmosphere surrounding the substrate. The substrate me be portion of a photovoltaic module. The substrate may include glass.

In another aspect, a system for measuring a displacement in a portion of an object comprising an intended profile may include one or more sensors configured to measure a displacement of a portion of an object as the object passes along a transport axis. The system may include a zone configured to receive an object. The zone configured to receive an object may be positioned along the transport axis. The one or more sensors may be located along a second axis intersecting the zone configured to receive an object, and substantially proximate to the zone.

The one or more sensors may include an optical micrometer. The one or more sensors may include a laser displacement sensor. The one or more sensors may include a first sensor and a second sensor aligned along a second axis substantially perpendicular to the transport axis. The zone configured to receive an object may be located in between the first sensor and the second sensor. The one or more sensors may be configured to measure a displacement of a portion of an article transported through the zone configured to receive a substrate. The system may include a microprocessor in connection with the one or more sensors.

In another aspect, a system for measuring defects in a substrate may include one or more sensors configured to measure defects in a substrate. The system may include a zone configured to receive a substrate. The zone configured to receive a substrate may be positioned along a first axis for transporting a substrate. The one or more sensors may be located along a second axis intersecting the zone configured to receive a substrate, and substantially proximate to the zone. The system may include a microprocessor, in communication with the one or more sensors, configured to determine a second substrate profile for a substrate traversing the first axis and passing through the zone configured to receive a substrate. The microprocessor may be configured to compare a first substrate profile with the second substrate profile to determine a defect value.

The defect value may correspond to one or more defects on an edge of the substrate. The defect value may correspond to one or more defects on a non-coated edge of the substrate. The substrate may be a portion of a photovoltaic module. The first substrate profile may correspond to a set of measurements for a theoretical substrate. The microprocessor may be configured to compare the determined defect value to a threshold value. The microprocessor may be configured to output a STOP signal to halt processing of the substrate if the defect value exceeds the threshold value. The microprocessor may be configured to output a signal directing a manufacturing system to relocate the substrate to an inspection region if the defect value exceeds the threshold value. The substrate may be a portion of a photovoltaic module.

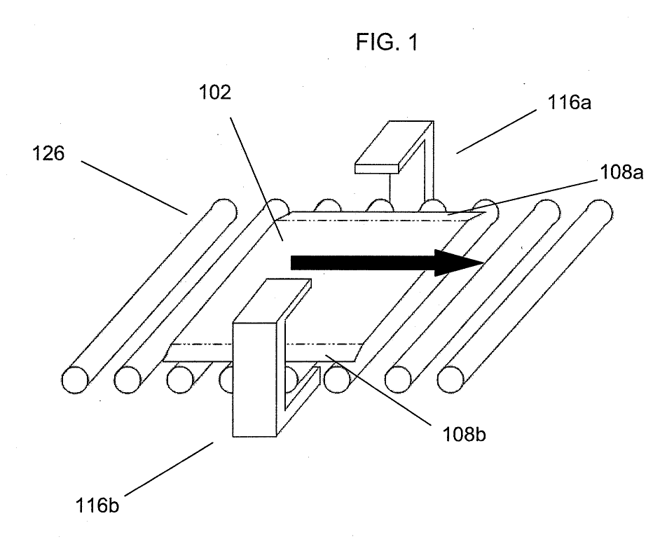

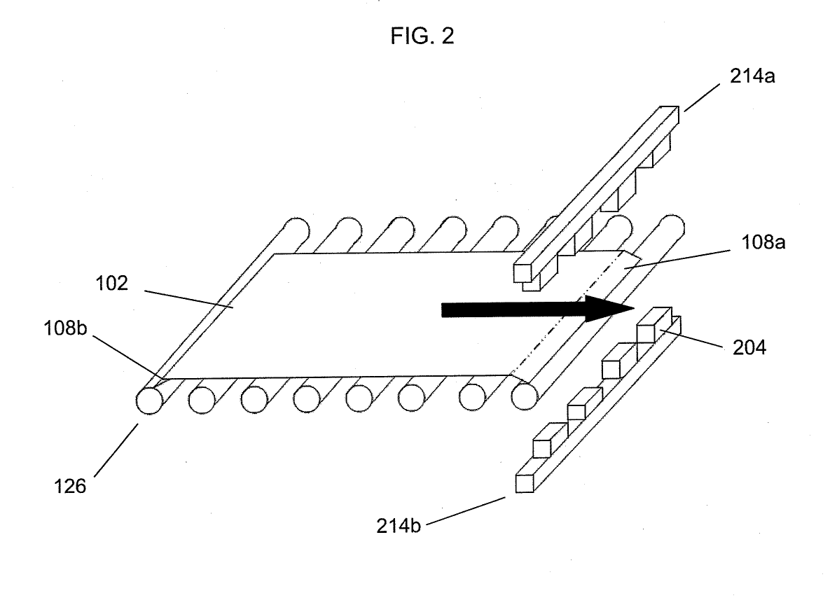

Referring to FIG. 1, a system for measuring a defect in a object, such as a displacement, deformation, or deflection of a surface of an object, such as substrate 102, may include sensors 116a and 116b positioned along a transport axis. One or more conveyor rollers 126 may be positioned along the transport axis to transport a photovoltaic module or substrate, including, for example, substrate 102. Substrate 102 may include any suitable substrate material, including, for example, a glass (e.g., soda-lime glass). Substrate 102 include one or more layers of coating on its surface, including, for example, one or more semiconductor layers (e.g., cadmium telluride) suitable for harnessing solar energy. Substrate 102 may be transported via conveyor rollers 126 along the transport axis. Substrate 102 may be positioned on any other suitable transport means. For example, substrate 102 may be positioned on a shuttle, which may be placed on conveyor rollers 126. The shuttle and/or conveyor rollers 126 may be used to transport substrate 102 to various manufacturing stations. Thus the systems depicted in FIGS. 1 and 2 may correspond to a single zone or step of the manufacturing process. The manufacturing process can pertain to the fabrication of any suitable materials, devices, or components, which may require use of a substrate. Thus the systems discussed herein may be suitable for any substrate, where monitoring defects, distortions, or kinks in any portion thereof would be desirable.

Sensors 116a and 116b may be positioned along the axis of transport for substrate 102 in any suitable position. For example, sensors 116a and 116b may be positioned on opposite sides of the transport axis, on another axis perpendicular to the transport axis. Each of sensors 116a and 116b may contain an upper portion and a lower portion. The upper portion may be positioned above an area along the transport axis through which substrate 102 may pass. The lower portion may be positioned below an area along the transport axis through which substrate 102 may pass. With such a configuration, substrate 102, upon passing along the transport axis, will be positioned between lower and upper portions of sensors 116a and 116b.

Sensors 116a and 116b can be of any suitable size, and may have components that extend adjacent to any suitable area of the substrate for measuring. For example, the upper and lower portions of 116a and 116b may protrude into an area just below or above conveyor rollers 126 such that the upper and lower portions lie adjacent to opposing edges 108a and 108b of substrate 102 once it passes through the area. The position of these upper and lower portions may permit each of sensors 116a and 116b to measure a respective edge of substrate 102 for physical defects. For example, sensors 116a and 116b may measure a deviation of an edge of substrate 102 from a plane parallel to the transport axis. Sensors 116a and 116b may be configured to take measurements at one or more locations along an edge of substrate 102. Thus sensors 116a and 116b may determine that multiple locations along an edge of substrate 102 are not in-line with the preferred planar orientation of the substrate. Sensors 116a and 116b may include any suitable devices for measuring planar defects, including, for example, any suitable optical micrometer or laser displacement sensor.

The system can detect a defect, deformation, or displacement of substrate 102 by comparing the measurements taken by sensors 116a and/or 116b representing an actual object shape or profile of substrate 102 to an intended object shape or profile of substrate 102. If the actual object shape or profile of substrate 102 is substantially the same as the intended object shape or profile, substrate 102 can be deemed to be within specifications. If the actual object shape or profile of substrate 102 is substantially different from the intended object shape or profile of substrate 102, a defect, deformation, or displacement is detected and substrate 102 can be deemed defective or outside specifications. The system is capable of detecting the shape or curvature (including a planar curvature) of substrate 102 to within 1 mm, within 100 pm, or within 10 pm, or another other suitable accuracy capable of being provided by sensors 116a and/or 116b.

FIG. 2 depicts an alternative configuration of a measurement system, in which sensors 214a and 214b are respectively positioned above and below conveyor rollers 126, such that upon its traversal of the transport axis, one or more portions of substrate 102 are positioned in between sensors 214a and 214b. Sensors 214a and 214b may have various measuring components 204, allowing each of sensors 214a and 214b to measure one or more areas on substrate 102, including for example, either of edges 108a and 108b. The configuration of FIG. 2 is such that the sensors may scan the entire substrate for planar defects. This may include all coated and non-coated portions of substrate 102.

Any of sensors 214a, 214b, 116a, and 116b may be connected to one or more electronic devices for storage or manipulation of any of the data measured. For example, the sensors may be connected to a memory component (or may have memory stored within). The sensors may also be connected to a microprocessor, which may be configured to determine whether any of the measured defects fall within an acceptable range of error. The microprocessor may have a threshold defect value, and may be configured (via software operating on computer hardware) to compare measured values against this threshold. The microprocessor may be configured to output an alert signal if one or more measured values extends beyond the threshold value. The alert signal may take any suitable form. For example, the alert signal may be a sound to indicate to those in the manufacturing facility that processing on the current module may need to halt. Upon stoppage of processing, the module can be removed from the assembly line for further inspection. It may be determined from further inspection that the substrate ought to be scrapped, as further manufacturing may lead to fabrication of a module which does not meet performance standards.

Alternatively, the alert may be a simple output signal. For example, the microprocessor may output a HIGH signal to a computer, network, or other system. The HIGH signal may constitute any appropriate means to indicate the alert, including, for example, more than −5 V, more than 0 V, more than 5 V, or less than 10 V. The microprocessor may also be configured to output a LOW signal, which may be represented by any appropriate voltage output, including, for example, less than 10 V, less than 5 V, less than 0 V, or more than −5 V. The computer, network, or system which receives the signal may initiate a programmed response. This may involve automatic halt of the manufacturing line or initiation of an alternative manufacturing process. For example, upon receiving an alert that a module substrate contains defects falling outside the acceptable margin of error, the module may be automatically transferred to a zone for one or more defect-curing steps. The defect-curing steps may involve the use of one or more heaters to cause thermal deformation within the substrate to “bend” the substrate to an acceptable position.

Photovoltaic modules fabricated using the methods and systems discussed herein may be incorporated into a system for generating electricity. For example, a photovoltaic module may be illuminated with a beam of light to generate a photocurrent. The photocurrent may be collected and converted from direct current (DC) to alternating current (AC) and distributed to a power grid. Light of any suitable wavelength may be directed at the module to produce the photocurrent, including, for example, more than 400 nm, or less than 700 nm (e.g., ultraviolet light). Photocurrent generated from one photovoltaic module may be combined with photocurrent generated from other photovoltaic modules. For example, the photovoltaic modules may be part of a photovoltaic array, from which the aggregate current may be harnessed and distributed.

Although the methods and systems discussed herein may be applicable for the manufacturing of photovoltaic modules, they are not necessarily limited to such circumstances. To the contrary, the aforementioned methods and systems may be used to detect or measure defects in any substrate, for any suitable purpose. Further, such methods and systems may also be useful for measuring and verifying the surface topology of any type of object, for which deviation from the horizontal plane is a parameter of interest.

The embodiments described above are offered by way of illustration and example. It should be understood that the examples provided above may be altered in certain respects and still remain within the scope of the claims. It should be appreciated that, while the invention has been described with reference to the above preferred embodiments, other embodiments are within the scope of the claims.

1. A method of measuring a displacement in a portion of an object having an intended shape, the method comprising:
detecting a displacement of a portion of an object compared to the intended placement of the portion with one or more sensors positioned along a first axis for transporting the object.

2. The method of claim 1, wherein the detecting occurs as the object traverses the first axis.

3. The method of claim 1, wherein the one or more sensors comprises two sensors aligned along a second axis substantially perpendicular to the first axis, wherein the two sensors are positioned on opposite sides of the first axis.

4. The method of claim 1, wherein the detecting comprises measuring a displacement along an edge of the object.

5. The method of claim 1, wherein the object comprises a planar surface.

6. The method of claim 1, wherein the object comprises a substrate.

7. The method of claim 6, wherein the substrate comprises a substrate configured for use in a photovoltaic module.

8. The method of claim 6, wherein the substrate comprises glass.

9. The method of claim 6, wherein the detecting comprises measuring displacement along a non-coated region of the substrate.

10. A method of measuring a defect in a portion of an object having an intended profile comprising:
determining an intended object profile;
determining an actual object profile for an object traversing a first axis for transporting the object; and
comparing the intended object profile with the actual object profile to determine a defect value.

11. The method of claim 10, wherein the defect value corresponds to one or more defects on a portion of the object.

12. The method of claim 10, wherein the portion comprises an edge portion.

13. The method of claim 12, wherein the defect value corresponds to one or more defects on a non-coated edge of the object.

14. The method of claim 10, wherein the object comprises a planar substrate.

15. The method of claim 10, wherein the intended object profile corresponds to a set of measurements for a theoretical object.

16. The method of claim 10, further comprising comparing the defect value to a threshold value.

17. The method of claim 14, further comprising halting processing of the substrate if the defect value exceeds the threshold value.

18. The method of claim 14, further comprising relocating the substrate to an inspection region if the defect value exceeds the threshold value.

19. The method of claim 14, further comprising continuing with processing of the substrate if the defect value does not exceed the threshold value.

20. The method of claim 14, further comprising curing one or more defects in the substrate if the defect value exceeds the threshold value.

21. The method of claim 20, wherein the curing comprises raising or lowering a temperature in an atmosphere surrounding the substrate.

22. A system for measuring a displacement in a portion of an object comprising an intended profile, comprising:
one or more sensors configured to measure a displacement of a portion of an object as the object passes along a transport axis.

23. The system of claim 22, further comprising a zone configured to receive an object, wherein the zone is positioned along the transport axis, wherein the one or more sensors are located along a second axis.

24. The system of claim 22, wherein the one or more sensors comprises an optical micrometer.

25. The system of claim 22, wherein the one or more sensors comprises a laser displacement sensor.

26. The system of claim 23, wherein the one or more sensors comprises a first sensor and a second sensor aligned along the second axis substantially perpendicular to the transport axis, wherein the zone is located in between the first sensor and the second sensor.

27. The system of claim 23, wherein the one or more sensors are configured to measure a displacement of a portion of an object transported through the zone.

28. The system of claim 22, further comprising a microprocessor in connection with the one or more sensors.

29. A system for measuring defects in a substrate, the system comprising:
one or more sensors configured to measure defects in a substrate;
a zone configured to receive a substrate, wherein the zone is positioned along a first axis for transporting a substrate, wherein the one or more sensors are located along a second axis intersecting the zone, and substantially proximate to the zone; and a microprocessor, in communication with the one or more sensors, configured to:
determine a second substrate profile for a substrate traversing the first axis and passing through the zone; and
compare a first substrate profile with the second substrate profile to determine a defect value.

30. The system of claim 29, wherein the defect value corresponds to one or more defects on an edge of the substrate.

31. The system of claim 29, wherein the defect value corresponds to one or more defects on a non-coated edge of the substrate.

32. The system of claim 29, wherein the first substrate profile corresponds to a set of measurements for a theoretical substrate.

33. The system of claim 29, wherein the microprocessor is further configured to compare the determined defect value to a threshold value.

34. The system of claim 33, wherein the microprocessor is further configured to output a STOP signal to halt processing of the substrate if the defect value exceeds the threshold value.

35. The system of claim 33, wherein the microprocessor is further configured to output a signal directing a manufacturing system to relocate the substrate to an inspection region if the defect value exceeds the threshold value.
